(19) United States
(12) Patent Application Publication
(10) Pub. No.: US 2005/0109898 A1
(43) Pub. Date: May 26, 2005

(54) Positioning foot for an instrument stand

(76) Inventor: Wu-Hong Hsieh, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/718,672

(22) Filed: Nov. 24, 2003

(51) Int. Cl. F16M 11/20

(52) U.S. Cl. 248/188.9

(57) ABSTRACT

A positioning foot for an instrument stand having legs extending out of the instrument stand, has pads adapted to be respectively mounted on a corresponding free end of the legs, each pad having a through hole defined through the pad and a groove defined in a side face of the pad, and spikes each pivotally received in a corresponding one of the grooves of the pads to be alternatively extended out to engage with a surface to provide a firm grip to the instrument stand.

### BACKGROUND OF THE INVENTION

1. Field of the Invention

The present invention relates to a positioning foot for an instrument stand, and more particularly to a positioning foot having a spike alternatively extending out of the positioning foot to cope with different surfaces of performance sites.

2. Description of Related Art

A stand for a musical instrument is to support the music instrument, such as a drum, while the instrument is played. A firm grip to the performance surface is crucial such that the performer is able to play the instrument without any distraction. With reference to FIG. 9, a conventional stand (50) for musical instruments is shown and has legs (51) extending out from the stand (50). Each leg (51) is provided with a rubber sheath (60) surrounding the free end of the leg (51). Because the conditions of the performance sites vary, the rubber sheath (60) may not provide a firm grip to the performance surface and the stand may slide during the performance. Accordingly, the performer is not able to play the instrument without the interruption of correcting the stand.

To overcome the shortcomings, the present invention tends to provide an improved positioning foot to mitigate the aforementioned problems.

### SUMMARY OF THE INVENTION

The primary objective of the present invention is to provide an improved positioning foot for an instrument stand. The positioning foot has a spike alternatively extending out of the positioning foot such that the positioning foot is able to cope with different terrain and still provide stable grip to the performance surface.

Another objective of the present invention is to provide a positioning foot having a pad adapted to be securely mounted on a distal end of the stand leg to provide a firm grip to the surface.

Other objects, advantages and novel features of the invention will become more apparent from the following detailed description when taken in conjunction with the accompanying drawings.

### BRIEF DESCRIPTION OF THE DRAWINGS

FIG. 1 is perspective view showing the practical application of the positioning foot of the present invention with an instrument stand;

FIG. 2 is an exploded perspective view showing the parts of the positioning foot in FIG. 1;

FIG. 3 is a perspective view showing the assembled positioning foot;

FIG. 4 is a schematic cross sectional view showing that the spike is received in the pad when the spike is not in use;

FIG. 5 is a schematic cross sectional view showing that the knob is rotated to loosen the spike;

FIG. 6 is a schematic cross sectional view showing that the spike is pushed out of the pad after the spike is loosened;

FIG. 7 is a schematic cross sectional view showing that the spike is pivoted for application;

FIG. 8 is a schematic cross sectional view showing that the knob is tightened to secure the spike in the pad for practical application; and

FIG. 9 is a perspective view showing a conventional sheath for an instrument stand.

### DETAILED DESCRIPTION OF THE PREFERRED EMBODIMENT

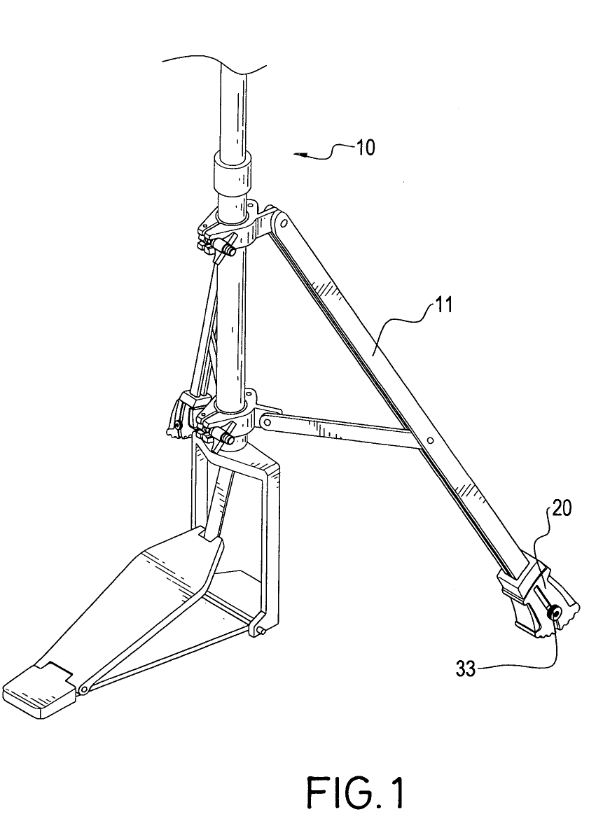

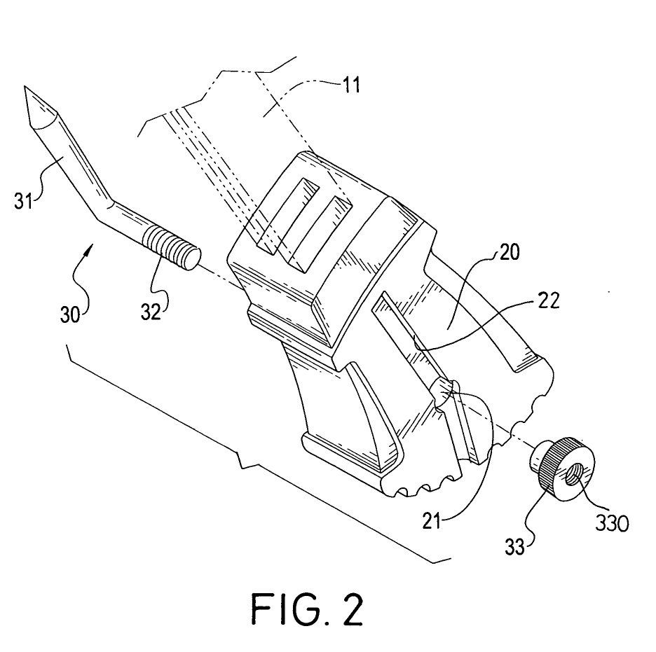

With reference to FIGS. 1 and 2, the positioning foot for an instrument stand (10) having legs (11) extending out of the instrument stand (10) has a pad (20) and a spike (30).

The pad (20) is made of rubber and has a through hole (21) laterally defined through the pad (20) and two grooves (22) each oppositely defined in a side face of the pad (20).

The spike (30) is L-shaped and divided into an engaging end (31) and a connecting end (32). The engaging end (31) has a sharp distal end and the connecting end (32) has an outer thread formed on an outer periphery of the connecting end (32). A knob (33) has a hole (330) extending through the knob (33) to correspond to the connecting end (32) of the spike (30).

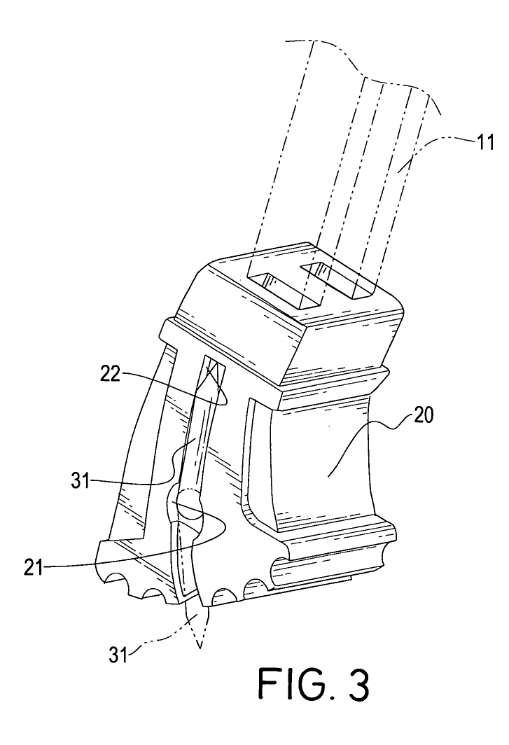

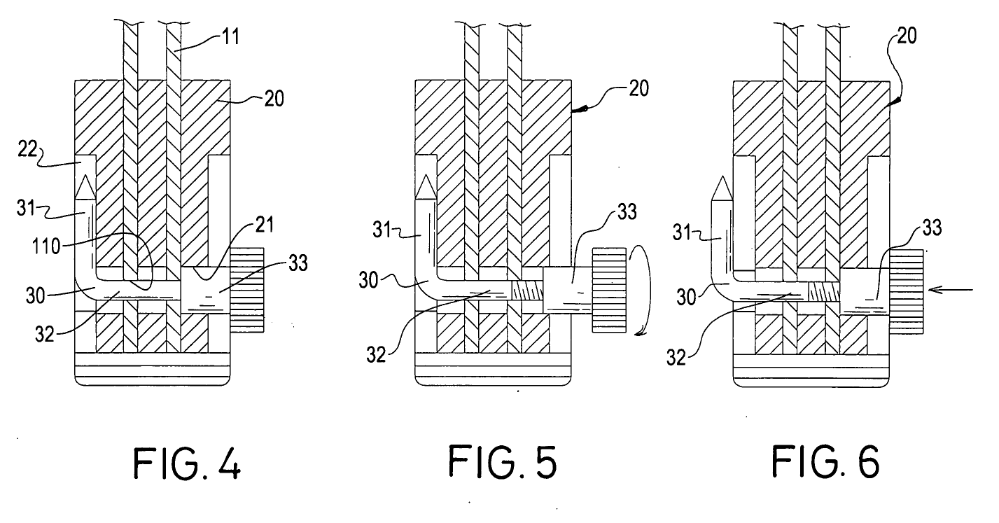

With reference to FIGS. 3 and 4, it is noted that when the positioning foot of the present invention is in assembly, the connecting end (32) is extended through the through hole (21) of the pad (20) and then the knob (33) is threadingly connected to the connecting end (32) of the spike (30), whereas the engaging end (31) is received in either one of the grooves (22) of the pad (20). Preferably, the leg (11) also has an extension hole (110) in alignment with the through hole (21) such that when the connecting end (32) is extended through the through hole (21), the connecting end (32) also extends through the extension hole (110) of the leg (11) (as shown in FIG. 4).

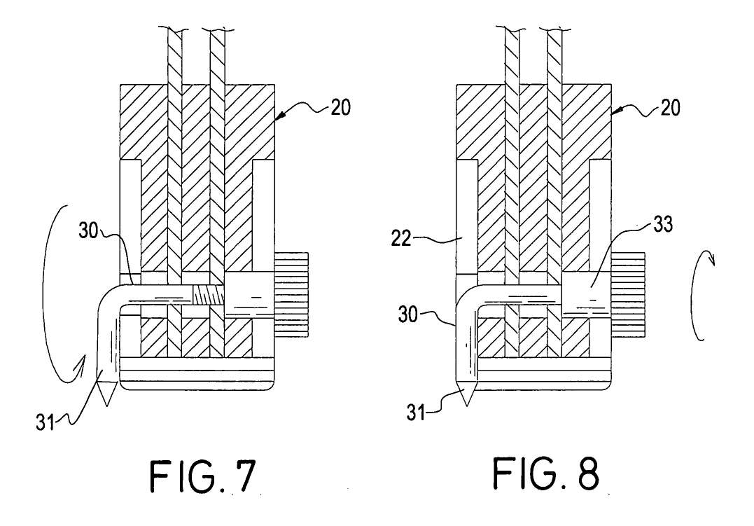

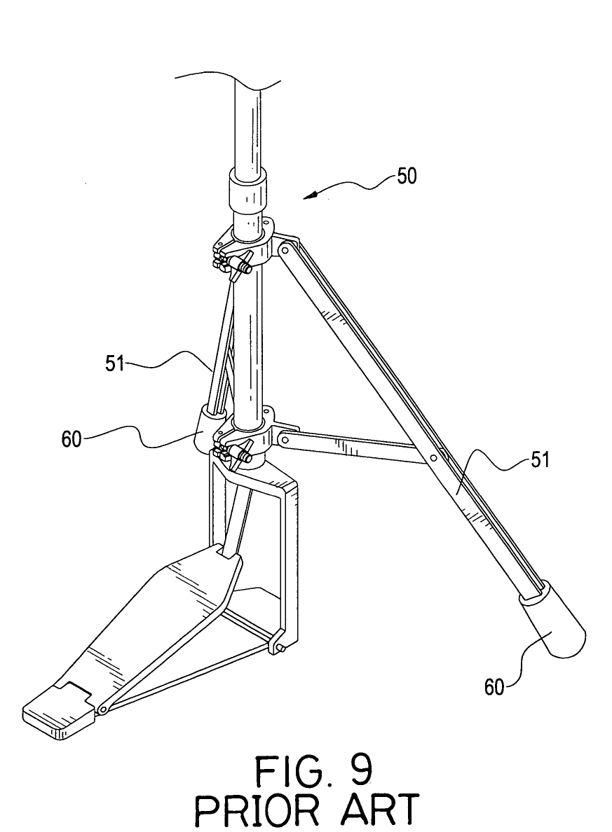

With reference to FIGS. 5, 6, 7 and 8, when the performance surface is slippery and the rubber pad (20) is unable to provide a firm grip to the surface, the operator may unscrew the knob (33) to loosen engagement between the engaging end (31) and an inner face defining the corresponding groove (22) and then push the knob (33) to allow the engaging end (31) to extend out of the groove (22). Downward pivotal movement of the spike (30) enables the engaging end (31) to point to the surface to be engaged. Thereafter, the operator tightens the knob (33) to secure the spike (30) to the pad (20). Thus the engaging end (31) engages with the performance surface and is able to provide a firm grip to the performance surface and the instrument stand (20) is able to stably support the instrument (not shown) thereon.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A positioning foot for an instrument stand having legs extending out of the instrument stand, the positioning foot comprising:
pads each adapted to be respectively mounted on a corresponding free end of the legs, each pad having a through hole defined through the pad and a groove defined in a side face of the pad; and
spikes each pivotally and slidably received in a corresponding one of the pads to be adjustably extended transversely outward and pivotally displaced relative thereto for engagement with a supporting surface, and thereby provide a firm grip to the instrument stand.

2. The positioning foot as claimed in claim 1, wherein each pad has two grooves respectively defined in two opposite side faces of the pad.

3. The positioning foot as claimed in claim 2, wherein the spike is divided into an engaging end and a connecting end and has a knob screwingly connected to the connecting end such that the spike is able to pivot relative to the knob.

4. The positioning foot as claimed in claim 1, wherein each of the spikes includes engaging and connecting ends offset in angular orientation one from the other, the connecting end passing through one of the pads to be releasably locked thereto by an adjustable knob, the engaging end being in a first position selectively received recessed manner in one groove of the pad and in a second position protruded therefrom for engaging the supporting surface.

5. The positioning foot as claimed in claim 4, wherein the engaging and connecting ends define substantially an L-shape for each of the spikes.
